(19) United States
(12) Patent Application Publication
(10) Pub. No.: US 2008/0150701 A1
(43) Pub. Date: Jun. 26, 2008

(54) Method and apparatus for forming plastics with integral RFID devices

(76) Inventor: Alan Randmae, Northport, NY (US)

Correspondence Address: KEUSEY, TUTUNJIAN & BITETTO, P.C., 20 CROSSWAYS PARK NORTH, SUITE 210, WOODBURY, NY, 11797, US

(21) Appl. No.: 11/645,417

(22) Filed: Dec. 26, 2006

(51) Int. Cl. H04Q 5/22; G08B 13/14; B29C 45/14

(52) U.S. Cl. 340/10.5; 340/572.8; 425/573

(57) ABSTRACT

An apparatus for injection molding plastic articles with integral RFID tags includes an injection molding machine comprising a melt reservoir, a plunger, heating elements, an injection nozzle, a hot runner passageway, a mold having at least one mold cavity, and an RFID injection element having a valve and an RFID hopper? The method for creating injection molded plastic articles having integrally molded RFID tags includes injecting an RFID tag into liquid plastic resin during the injection molding process.

### FIELD OF THE INVENTION

The present principles generally relate to plastic items, more particularly, to plastic items with Radio Frequency Identification (RFID) tags integrally disposed therein.

### BACKGROUND OF THE INVENTION

Plastics are currently used worldwide as an inexpensive, easily made, and infinitely customizable material for making a variety of products. Plastics are particularly suitable for making vessels for containing liquids because of plastic's low chemical volatility and waterproof characteristics. However, one of the primary drawbacks of using plastics is that plastic does not degrade easily in landfills.

Many governments and companies have mandated extensive recycling and the reuse of recylcable materials in an attempt to reduce the volume of plastics being sent to landfills. In order to properly recycle various kinds of plastics, it is necessary to separate each different type of plastic prior to recycling. For example, Polyethylene Terephthalate (PET), such as soda and water containers must be separated from oil and milk bottles made from High-Density Polyethylene (HDPE), before each material can be reused.

Traditionally, recyclers have relied on consumers for sorting and then the subsequent complicated and expensive separation processes at the plants. However, most consumers only separate plastics from paper and metal products. Separating different types of plastics in a single stream of refuse can be time consuming manual work, or involve expensive or destructive processes.

Additionally, some plastic containers are not suitable for general recycling. Plastic containers that hold certain chemicals such as pesticides or petroleum based oils may become contaminated. Even small amounts of contamination of these plastic containers could make reuse of the plastics unsuitable for food quality plastic recycled containers. Furthermore, cross contamination of chemicals is possible if the plastic containers are improperly cleaned before the container is reused or recycled.

For example, the European Economic Community has enacted guidelines directing pesticides to be stored in reusable 30-50 liter plastic containers. The regulations require that the containers may not be used for different chemicals, instead requiring that the reusable plastic containers be reused for the same chemical types.

U.S. Pat. No. 4,884,386, granted to Carlo Dec. 5, 1989, describes separating various plastic types for recycling by sending X-rays through each plastic article, then examining the absorbed X-rays to determine the plastic type.

U.S. Pat. No. 5,616,641, granted to Basch Apr. 1, 1997, describes an improved method for separating plastic types by floatation, the flotation medium's specific weight being varied by the addition of salts to allow certain plastic types to float.

U.S. Pat. No. 6,216,878 granted to Wheat Apr. 17, 2001 describes differently coloring specific types of plastics before use, then separating the plastic types by color upon recycling.

U.S. Pat. No. 5,894,939 granted to Frankel in Apr. 20, 1999 teaches a method for sorting recyclable plastic by irradiating plastic items with polarized light, which is then detectable by a person wearing filtered lenses.

However, none of these patents teaches an easily automated, non-destructive, inexpensive system for sorting recyclable plastic materials.

Radio Frequency Identification (RFID) tags are a technology well known in the electronics industry, and could effectively and inexpensively allow recyclers to sort plastics for recycling and reuse.

RFID tags are comprised of an integrated chip containing data and an antenna for receiving and transmitting the data to a wireless reader via radio. As the cost of RFID tags has dropped, the tags have been used in applications such as theft prevention, inventory tracking, access control, personal identification and remote data collection.

In the article Using RF/ID to Track Recyclable Container, (Senger, Nancy; Business Solutions Magazine, March 1999), the use of Radio Frequency Identification (RFID) tags attached to reusable plastic containers is disclosed as a method for tracking various kinds of information relating to the attached container. This article describes mounting the RFID tag into the container's upper rim.

United States Patent Application No. 20030234718 in the name of Fujisawa, field Dec. 25, 2003, discloses a method for tracking RFID attached objects, and preventing counterfeiting of RFID information using a database.

What can radio frequency identification do for pharmaceutical packaging? (Forcino, Hallie; Pharmaceutical Technology, May 2, 2003) discusses the use of RFID tags being used for inventory and shelf stock monitoring purposes. In particular, the article suggests incorporating the RFID tags into the labels placed on bottles.

None of the above cited prior art suggests a method for attaching an RFID tag to a plastic container in a way such that the RFID tag is protected from physical removal, or from physical damage as a result of handling.

What is needed is a method for easily identifying various types of plastics, and the material the plastic was used to contain. Preferably, this method would incorporate the use of RFID tags. Therefore, a method is also needed for securely attaching or embedding RFID tags in plastic containers.

### SUMMARY

These and other drawbacks and disadvantages of the prior art are addressed by the present principles, which is directed to plastic articles with integrated RFID tags, and various apparatus and methods for incorporating RFID tags during the manufacture of such plastic articles.

According to one implementation, the apparatus for injection molding plastic articles with RFID tags integrally molded therein includes an injection molding machine and a mold having at least one mold cavity. The mold is disposed in relation to the injection molding machine such that a liquid plastic resin may be forced into the at least one mold cavity from the injection molding machine. At least one RFID injection element capable of delivering at least one RFID tag into the liquid plastic resin is provided during the manufacturing process.

The method for making an injection molded plastic article, according to an implementation of the present principles, includes melting a plastic resin into a liquid plastic resin within an injection molding machine, beginning injection of the liquid plastic resin into a mold having a mold cavity, where the plastic is injected into the mold cavity through an injection nozzle disposed within the injection molding machine. The method further includes injecting at least one RFID tag into the liquid plastic resin, and finishing injecting the liquid plastic resin into a mold, where the RFID tag being carried into the mold cavity.

According to another aspect, the method includes a method for sorting at least one plastic article based on at least one property. The method includes the steps of reading information from an RFID tag integrally molded within the at least one plastic articles, determining the type of plastic material the article is made from based on said information and separating the plastic articles based on the determining of the type of plastic material.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 shows a cross-sectional view of a typical plunger type injection molding machine according to the prior art;

FIG. 2 shows a cross-sectional view of a typical screw-type reciprocating injection molding machine according to the prior art;

FIG. 3a shows a cross-sectional view of a plunger type injection molding machine capable of injecting an RFID tag directly into the mold cavity in accordance with the present principles;

FIG. 3b shows a cross-sectional view of a plunger type injection molding machine capable of injecting an RFID tag into the injection nozzle cavity in accordance with the present principles;

FIG. 3c shows a cross-sectional view of a plunger type injection molding machine capable of injecting an RFID tag into the melt reservoir in accordance with the present principles;

FIG. 4a shows a cross-sectional view of a screw-type reciprocating injection molding machine capable of injecting an RFID tag directly into the mold cavity in accordance with the present principles;

FIG. 4b shows a cross-sectional view of a screw-type reciprocating injection molding machine capable of injecting an RFID tag into the injection nozzle cavity in accordance with the present principles;

FIG. 4c shows a cross-sectional view of a screw-type reciprocating injection molding machine capable of injecting an RFID tag into the melt reservoir in accordance with the present principles;

FIG. 5 shows a cross-sectional view of a hot runner system adapted for use with a multiple cavity mold, the hot runner system capable of injecting an RFID tag into the hot runner, in accordance with the present principles.

FIG. 6a shows a cross-sectional view of a plastic extrusion machine capable of injecting an RFID tag through the extrusion die in accordance with the present principles.

FIG. 6b shows a cross-sectional view of a plastic extrusion machine capable of injecting an RFID tag into the melt cavity in accordance with the present principles.

### DETAILED DESCRIPTION

The present principles are directed to an apparatus and method for injection molding plastic articles with embedded RFID tags.

The following description illustrates the present principles. It will thus be appreciated that those skilled in the art will be able to devise various arrangements that, although not explicitly described or shown herein, embody the present principles and are included within their spirit and scope.

All examples and conditional language recited herein are intended for pedagogical purposes to aid the reader in understanding the present principles and the concepts contributed by the inventor to furthering the art, and are to be construed as being without limitation to such specifically recited examples and conditions.

Furthermore, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure. It will, therefore, be appreciated by those skilled in the art that the figures presented herein represent conceptual views of illustrative machinery embodying the present principles.

In the claims hereof, any element expressed as a means for performing a specified function is intended to encompass any way of performing that function, including, for example, a combination of electrical, mechanical, hydraulic or pneumatic elements that performs that function. The present principles, as defined by such claims, reside in the fact that the functionalities provided by the various recited means are combined and brought together in the manner which the claims call for. Applicant thus regards any means that can provide those functionalities as equivalent to those shown herein.

Referring now to FIG. 1, a typical plunger type injection molding machine 100 is indicated. The plunger type injection molding machine 100 comprises, in part, an injection molding machine body 106, a melt reservoir 105, a hopper feed opening 107, a plunger 108, and a melt reservoir torpedo 110. The injection molding machine body 106 is dimensioned so that the melt reservoir 105 is enclosed by the injection molding machine body 106, allowing the melt reservoir to carry liquefied plastic resin. The hopper feed opening 107 is used to allow plastic resin pellets to enter the melt reservoir 105 when the plunger 108 is withdrawn past the hopper feed 107 opening. The plunger 108 reciprocates back and forth, allowing the plastic resin pellets in through the hopper feed 107 opening. After withdrawing, the plunger 108 is pushed forward, compressing the plastic resin pellets into the melt reservoir 105. Upon being pushed further forward, the plunger 108 forces the melted plastic resin out of the melt reservoir 105, performing the “injection shot”.

Outside of the injection molding machine body 106, are disposed a plurality of heating elements 109. The heating elements 109 are designed to raise the temperature of the plastic resin within the melt reservoir past the resin's glass transition point, effectively melting the plastic resin into a liquid state. Skilled practitioners of the art will recognize that the heating elements 109 may be of any type sufficient to deliver enough thermal energy. For example, the heating elements 109 may be an electric or a fluid heating type.

Disposed within the melt reservoir 105 is a melt reservoir torpedo 110. The melt reservoir torpedo 110 is dimensioned to force the plastic resin pellets to be directed to the sides of the melt reservoir 105. By directing the plastic resin pellets to the outside boundaries of the melt reservoir 105, the melt reservoir torpedo 110 causes the plastic resin pellets to be uniformly heated, helping to eliminate any volumes of lower temperature that may occur in the center of the melt reservoir 105. The melt reservoir torpedo 110 also raises the hydraulic pressure applied to the plastic resin pellets, further assisting in the uniform melting of the resin pellets. The plastic resin that passes the melt reservoir torpedo 100 into the front of the melt reservoir 105 is in a liquid state, uniformly melted.

The injection molding machine 110 may be further comprised of an injection nozzle 104 disposed in the injection molding machine body 106. The injection nozzle 104 is dimensioned to allow the melted plastic resin to pass through a hot runner 103 in the injection nozzle 104 from the melt reservoir 105. The injection nozzle 104 may further have heating elements 109 disposed within or around the injection nozzle 104 to assure that any plastic resin passing through the injection nozzle 104 remains in a liquid state. The passageway dimensioned within the injection nozzle is then a hot runner 103. Therein the plastic within the hot runner 103 is kept hot, and therefore liquid.

The injection molding machine body 105 and injection nozzle 104 are then disposed in relation to a mold 102 having at least one mold cavity 101, in a manner where the plastic resin may pass through the injection nozzle, into the mold cavity 101 disposed within the mold 102.

When sufficient molten plastic resin has accumulated in the melt reservoir 105, the plunger 108 is then pressed forward, forcing the liquid plastic resin from the melt reservoir, through the hot runner 103 disposed within the injection nozzle 104, and into the mold 102, to fill the mold cavity 101.

It is well known to practitioners of the art that a mold 102 may be cooled, through liquid or other means, to a temperature lower than the glass transition point of the plastic resin in use, causing the plastic resin to solidify within the mold cavity 101. The plastic resin then hardens in the shape of the mold cavity 101. The mold 102 halves are then separated, and the solid molded plastic part removed from the mold cavity 101.

The mold cavity 101 will be in the general shape of the article being molded. Additionally, the mold 102 may be comprised of more than two pieces, for example, to create more complex articles. The article of manufacture molded within the mold cavity 101 may be of any shape, and the mold 102 in any form or number of pieces without departing from the spirit of the present principles.

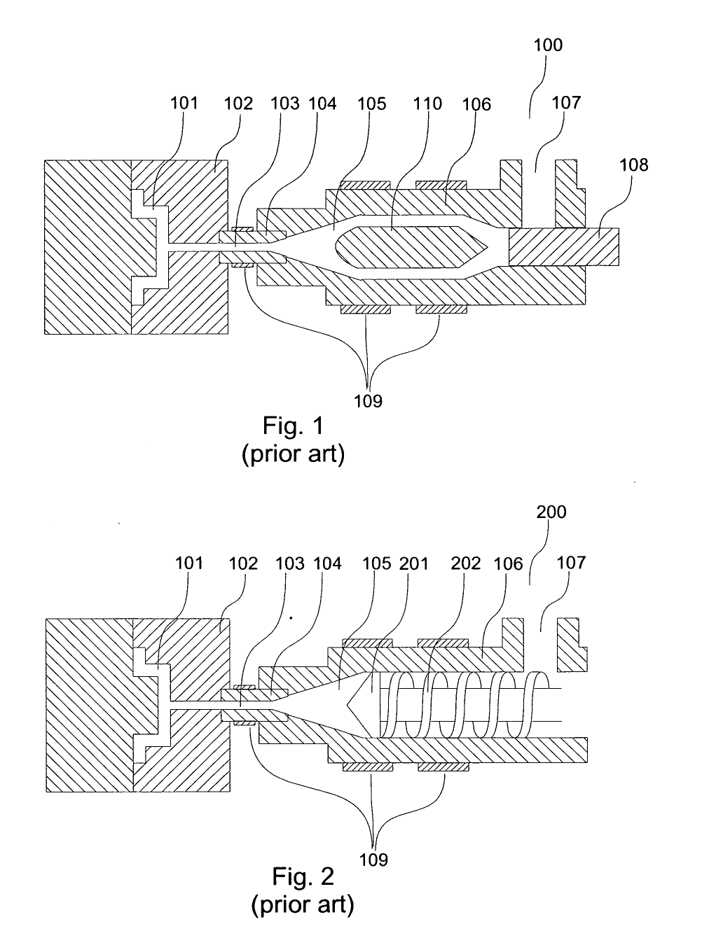

Referring now to FIG.2, a reciprocating screw-type injection molding machine 200 is indicated. This injection molding machine 200 includes an injection molding screw 202. The injection molding screw 202 includes, in part, a ram or screw tip 201. The injection molding screw is disposed within the melt reservoir 105 such that the threads of the injection molding screw extend past the hopper feed 107. Additionally, those practitioners skilled in the art will recognize that the screw tip 201 may be a standard extruder head, and may have a plurality of non-return flow valve assemblies disposed within the screw tip 201 to prevent liquefied plastic resin from flowing backwards into the screw 202 thread area.

In the reciprocating screw-type injection molding machine 200, solid plastic resin pellets are fed into the melt cavity 105 through the hopper feed opening 107. The plastic resin pellets are then engaged by the threads of the screw 202. The screw 202 rotates, compressing the plastic resin pellets while the plastic resin pellets are simultaneously heated by the heating elements 109. Skilled practitioners will recognize that the pressure applied to the resin can be applied by varying the distance between screw threads along the shaft of the screw, or by varying the thickness of the screw body along the length of the screw.

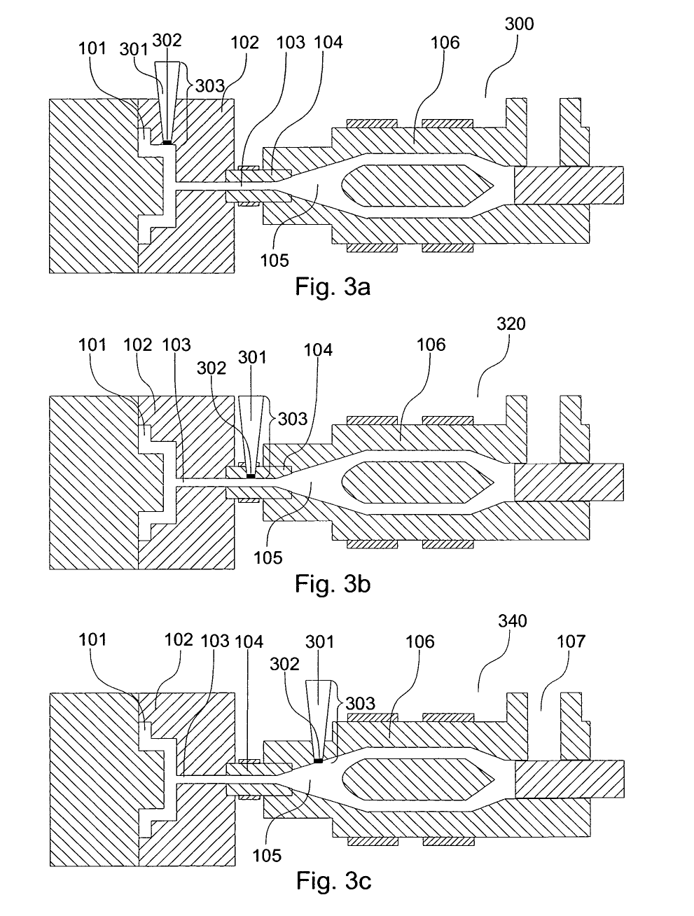

Referring now to FIG. 3a, one embodiment of the present principles is indicated. A plunger type injection molding machine 300 capable of embedding an RFID tag in a molded plastic article may include a standard plunger type injection molding machine, and an RFID injection element 303. The RFID injection element 303 may include an RFID hopper 301 for holding a plurality of RFID tags, and a valve 302 for controlling the flow of RFID tags into the injection molding machine.

Add paragraph describing an alternate feeding/supply mechanism for RFIDs whereby the RFIDs are in rolls, with tape backing, similar to autoinsertion and SMD components for automated PCB manufacturing.

In this preferred embodiment, the RFID injection element 303 is disposed in such a manner as to inject at least one RFID tag directly into the mold cavity 101. The valve 302 may be disposed in the surface of the mold cavity 101 such that an RFID tag may be passed from the RFID hopper, through the valve 302, to enter directly into the mold cavity 101.

The RFID tags will preferably be injected into the mold cavity 101 without any air, which could otherwise cause bubbles in the finished plastic article. In one useful embodiment, the RFID tags are suspended in a volatile solvent when injected into the mold cavity 101. In another useful embodiment, the RFID tags are suspended in molten plastic resin, which is then injected into the mold cavity 101.

In yet another useful embodiment, the RFID tags may be encapsulated in a protective covering, such as a hardened plastic resin. The hardened plastic resin may be configured such that the encapsulated RFID tag fits within the RFID hopper 301 so that the RFID tag may be injected into the mold cavity 101 without a liquid carrier, and also without any air or other gases entering the mold cavity 101.

The valve 302 may be of a passive check valve, or an active valve, which may be activated either mechanically, electrically, or using a combination of electrical and mechanical means.

In one preferred embodiment of the RFID injection element 303, the valve 302 is a passive check valve. In this embodiment, RFID tags may be injected from the RFID hopper 301 through the check valve 302 via mechanical or hydraulic pressure. In the case of the RFID tags being suspended in a volatile solvent or in liquid plastic resin, one or more RFID tags may be injected directly into the mold cavity 101 by applying hydraulic pressure such that the liquid carrier is forced through the passive check valve 302, carrying one or more RFID tags into the mold cavity 101.

In another useful embodiment of the RFID injection element 303, the valve 302 is an active valve, electromechanically activated. Upon activation, the valve 302 opens, allowing one or more RFID tags to pass from the RFID hopper 301, through the valve 302, into the mold cavity 101.

Preferably, the RFID tag will be injected into the mold cavity 101 as the injection molding machine 300 begins the injection shot. This prevents the plastic resin material injected into the mold cavity 101 from hardening before the RFID tag is injected by the RFID injection element 303. In yet another useful embodiment, the RFID injection element 303 may be disposed within the mold 102, in such a way as to allow the injection of an RFID tag into a specific part of the mold cavity 101, so that the RFID tag may be embedded in the plastic article in a specified location.

FIG. 3b indicates another useful embodiment of the present principles. In this embodiment, a plunger type injection molding machine 320 capable of injection molding an RFID tag within a plastic article is indicated where the RFID tag may be delivered into the hot runner 103. Here, the RFID injection element 303 is disposed within the injection nozzle 104 such that RFID tags are injected directly into the hot runner 103 passageway of the injection nozzle 104. The valve 302 is disposed in the surface of the hot runner 103 such that RFID tags may be injected into the liquid plastic as the plunger 108 presses forwards, which carries the RFID tag into the mold cavity 101.

FIG. 3c indicates yet another useful embodiment of the present principles. In this embodiment, a plunger type injection molding machine 340 capable of injection molding an RFID tag within a plastic article is indicated, where the RFID tag may be delivered into the melt reservoir 105. Here, the RFID injection element 303 is disposed within the injection molding machine body 106. The valve 302 may be disposed in the surface of the melt reservoir 105 such that an RFID tag may be injected directly into the liquid plastic resin therein. One or more RFID tags will preferably be injected into the melt reservoir 105 just prior to the plunger 108 moving forward to deliver the liquid plastic resin to the mold cavity 101.

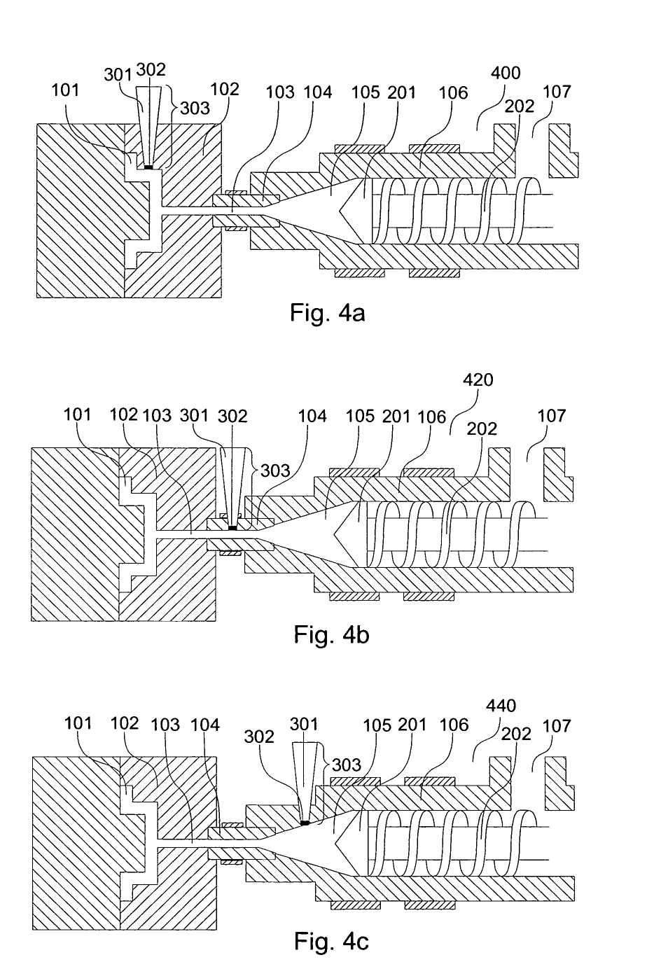

FIG. 4a indicates another preferred embodiment of the present principles. Here, a reciprocating screw type injection molding machine 400 capable of injection molding an RFID tag within a plastic article is indicated, where the RFID tag may be injected directly into the mold cavity 101. Here the RFID injection element 303 is disposed within the mold 102 of a reciprocating screw type injection molding machine 400 such that the valve 302 allows an RFID tag to be injected directly into the mold cavity 101. Here, the RFID tag will preferably be injected into the mold cavity 101 at the start of the injection shot forcing the liquid plastic resin into the mold cavity 101. In particularly useful embodiments, the RFID injection element 303 may be disposed within the mold 102, in such a way as to allow the injection of an RFID tag into a specific part of the mold cavity 101, so that the RFID tag may be embedded in the plastic article in a specified location.

FIG. 4b indicates another useful embodiment of the present principles. Here, a reciprocating screw type injection molding machine 420 capable of injection molding an RFID tag within a plastic article is indicated, where the RFID tag may be injected directly into the hot runner 103. Here the RFID injection element 303 is disposed within the injection nozzle 103 of a reciprocating screw type injection molding machine 420 such that the valve 302 allows an RFID tag to be injected directly into the hot runner 103 of injection nozzle 104 and is carried forward in conjunction with the molten plastic into the mold cavity 101.

FIG. 4c indicates yet another useful embodiment of the present principles. Here, a reciprocating screw type injection molding machine 440 capable of injection molding an RFID tag within a plastic article is indicated, where the RFID tag is injected into the melt reservoir 105. The RFID injection element 303 is disposed within the injection molding machine body 106 of a reciprocating screw type injection molding machine 440 such that the valve 302 allows an RFID tag to be injected directly into the melt reservoir 105. The RFID tag will preferably be injected into the melt reservoir just prior to the screw 102 moving forward to force the liquid plastic resin in the melt reservoir 105 into the mold cavity 101.

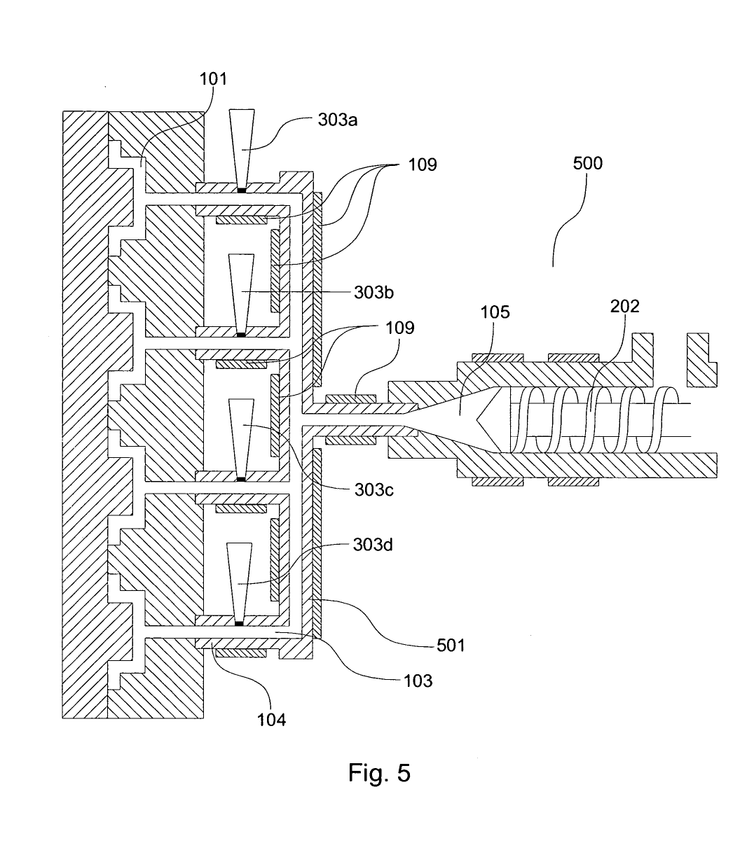

FIG. 5 indicates another preferred embodiment of the present principles as applied to an injection molding machine 500 with a hot runner system and multi-cavity mold. Molds with multiple cavities are frequently used for high volume injection molding systems. A hot runner system is commonly used to eliminate the need for sprues and runners within the mold, which allow the transfer of liquid plastic resin between multiple mold cavities 101. Sprues and runners within the mold, called cold runners, create a large amount of unused, waste plastic, as the molded plastic articles must be cut from the cold runner prior to use. The material in the cold runner is discarded after the usable plastic articles are removed, and the remaining plastic resin in the cold runner is therefore wasted.

A hot runner system is made up of a manifold 501, with heating elements 109 attached, to keep the plastic resin in liquid form while in the manifold 500. The manifold 500 may have one or more injection nozzles 104, which feed liquid plastic resin through a hot runner passage 103 directly into each mold cavity 101 disposed within the mold 102. In this manner, liquid plastic resin is delivered simultaneously to the mold cavities 101 when the liquid plastic resin is forced from the melt reservoir 105 by the screw 202 being pushed forward.

In this embodiment, the injection molding machine with a hot runner system 500 may have an RFID injection element 303a-d disposed within each of a plurality of injection nozzles 104. Therefore, each RFID injection element 303a-d may inject one or more RFID tags into the injection nozzle as the injection shot is performed, ensuring that at last one RFID tag is injected into each mold cavity 101. Were the RFID tag injected into the melt cavity 105, it would be difficult to ensure that at least one RFID tag was delivered to each mold cavity 101.

In another useful embodiment, the RFID injection elements 303a-d may be disposed within the mold 102 itself, with one RFID injection element 303a-d being associated with each mold cavity 101, respectively. The RFID injection elements 303a-d would, therefore, be able to deliver one or more RFID tags directly into each mold cavity 101.

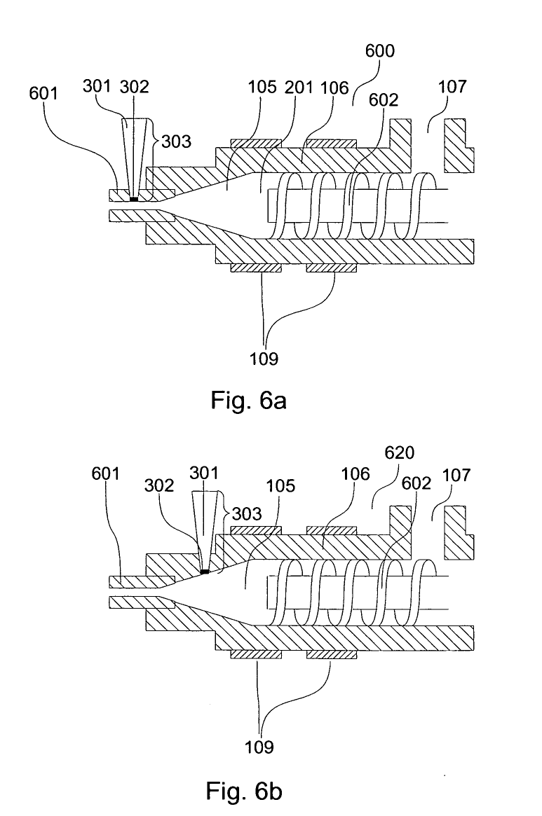

Referring to FIG. 6a, a plastic extrusion machine 600 capable of injecting an RFID tag through an extrusion die 601 in accordance with the present principles is described. At the outset, it should be noted that the extrusion process is similar to the injection molding process in that plastic material is liquefied prior to being shaped. The present principles advantageously inject an RFID tag into the plastic resin while the plastic resin is in a softened or liquid state.

It is known to skilled artisans that, in the extrusion process, solid plastic material is continually compressed and heated to soften or liquefy the plastic. This plastic resin, once softened, is then forced through a shaped extrusion die 601, giving shape to the plastic resin before the plastic hardens. Materials such as vinyl and other soft, non-precision plastics are frequently extruded to make products as diverse as tubing, vinyl siding, plastic bars and sheeting, plastic fibers and the like. The plastic resin is continuously forced through the extrusion die 601, allowing the extrusion process to manufacture products of almost limitless length.

To properly inject an RFID device into an extruded plastic article, an RFID injection element 303 maybe disposed within the extrusion die such that that RFID tags are injected into the extrusion molding die as the resin is forced through the extrusion die 601, embedding the RFID tag into the plastic article.

In one preferred embodiment, an extrusion machine 600 has a melt reservoir 105 disposed within the machine body 106. Plastic material is continuously fed via a hopper 107, to a compression screw 602 which compresses and melts the plastic in conjunction with heating elements 109. The continuous feed of the plastic material, and the continuous action of the compression screw 602 forces softened or molten plastic resin through an extrusion die 601, which gives the plastic resin shape. An RFID injection element 303 may advantageously be disposed within the extrusion die 601, injecting an RFID tag into the plastic resin as it passes through the extrusion die 601.

FIG. 6b illustrates an alternative placement of an RFID injection element 303. In this useful embodiment, the RFID injection element 303 may be disposed within the body 106 of the extrusion machine in such a way as to inject an RFID tag into the melt reservoir 105 of the extrusion forming machine 600. In one useful embodiment, the RFID injection element 303 may be disposed just inboard of the input side of the extrusion die 601, injecting an RFID tag into the plastic resin immediately prior to the resin being forced through the extrusion die 601. In yet another useful embodiment, RFID tags may be mechanically inserted into the molten plastic resin by means such as a mechanical arm or other mechanical insertion apparatus. Ideally, this mechanical arm would move at the same forward speed as the plastic resin, placing an RFID device into the plastic resin prior to the resin passing through the extrusion die 601. However, a mechanical insertion apparatus may also insert an RFID tag into the resulting formed plastic resin after the resin passes through the extrusion die 601, but prior to the resin hardening. Preferably, an RFID tag would be injected into the plastic resin at regular intervals, which allows the extruded plastic article to be cut into multiple pieces for sale or use, each piece containing at least one RFID tag.

Skilled practitioners of the art will recognize that the RFID tags used in an RFID injection molding system may be of any known type, or type as yet undiscovered. The RFID tags may be of a passive type, or may be an active type including a self contained power source. Additionally, the RFID tags may be writeable as well as readable, and may contain data relating to virtually any aspect of the plastic article the RFID tag is integrated into, or the contents of such container. For example, the data stored on the RFID tag may include, but not limited to: volume and type of the container material, plastic container material properties, application or contents of the plastic article, date of manufacture of the plastic article or codes indicated by the recycling industry. It should be noted, however, that some materials may degrade over time, or over multiple recycling or reuse cycles, and may need to be recycled with modified means. In such cases, it may be necessary to also include information such as the length of time used or number of times recycled. Additionally, any plastic article with an integrally molded RFID device may have the RFID device updated or overwritten when the plastic article is recycled or reused.

This data may be written to the RFID tag when the RFID tag is produced, prior to being integrally molded into a plastic article, subsequent to being molded into a plastic article, or at any time during the molding process. Furthermore, the RFID tag may be rewriteable at any time. In yet another useful embodiment, a writeable RFID tag may be able to accept data at the recycling plant, such as the chute or bin destination code, etc.

Additionally, the methods described herein may be advantageously used in any kind of plastic forming process. Ideally, any plastic forming process where the plastic is softened or liquefied to the point where the plastic may flow around the RFID tag to encase and embed the tag may be used according to the present principles.

For instance, RFID tags may be embedded in plastic articles created with any type of blow or stretch molding process. This blow molding process is commonly used to create soda and water bottles. Frequently, in blow or stretch molding, a preform, or blank is created using the injection molding process. For a plastic bottle, this preform may be a bubble or tube on one end, with a precision molded threaded neck for a bottle screw-on cap at the other end. This preform is then used to form the body of bottle through stretch molding. Generally, the precision molded end is encased in a solid collar, while air is blown into the remaining enclosed plastic cavity formed by the preform. When placed into a hollow mold and expanded with compressed air, the bubble end of the preform stretches and expands to take the form of the mold, creating the body of the bottle. The collar encasing the threaded neck of the bottle keeps the neck and thread portions of the bottle constant. In one useful embodiment, the RFID tag may be molded into the portion of the injection molded preform that remains constant throughout the blow molding process. Placing an RFID device into the collar or neck of the bottle may allow manufacturers and recyclers to use a constant or standardized article location for reading RFID devices, allowing for lower cost recycling with less guesswork as to the location of an RFID tag.

Similarly, in injection blow molding, plastic resin is injection molded around a core pin, which is then placed into a cooled mold. Once inside the mold, air is forced into the mold through the core pin, expanding the plastic resin to take on the shape of the mold. In a useful injection blow molding embodiment, an RFID tag may advantageously be injected into the plastic resin around the core pin, with the RFID tag disposed such that the RFID tag remains in a desired position after the blow molding process.

Likewise, extrusion blow molding allows a similar method of integral RFID molding. Initially in extrusion blow molding, plastic is melted and extruded into a hollow tube (a parison), which is then encased in a mold. One end of the parison is then closed off, and air is forced into the parison, inflating the still-elastic parison to fill the mold. In another useful embodiment, an RFID tag may be embedded in the plastic resin during the extrusion step, as detailed above for extrusion molding. During the blow molding phase of extrusion blow molding process, the RFID tag remains encased in the plastic resin, resulting in a molded plastic article with an RFID tag embedded therein.

Another form of plastic molding, rotational molding, may also advantageously apply the present principles. In rotational molding, plastic pellets are introduced into an enclosed mold, which is then heated and rotated. As the mold is heated, the plastic pellets inside begin to liquefy. The rotation of the mold permits the liquefied pellets to contact all of the inner surfaces of the mold. Once the mold has been sufficiently rotated and heated to a point where inner surfaces have an acceptable plastic resin built up, the mold is cooled and opened, wherein the plastic article is then removed. In yet another useful embodiment of the present principles, an RFID tag may be introduced into the mold when the plastic pellets are initially introduced into the mold, prior to the molding process. In such an embodiment, the RFID tag would adhere to the liquid plastic resin on the inner surface of the mold during the molding process, embedding the RFID tag in the plastic article. Preferably, the RFID tag would be of such, or encased in such material where the heat from molding process, while sufficient to liquefy the plastic pellets, is not great enough to melt or damage the RFID device or any material encasing the RFID tag.

Thermoforming, most commonly done using a vacuum forming or pressure forming process, is also a related plastic forming technique where the present principles may be advantageously applied. In vacuum forming, a plastic sheet is placed in a frame where it is heated until pliable. The softened plastic sheet is then placed onto a mold. A vacuum forming mold will have holes or other intakes disposed within the forming surface of the mold through which air is drawn. When the plastic sheet is placed over the mold, and air withdrawn out from the interior of the mold, a vacuum is formed, and the pliable plastic sheet is drawn onto the mold, allowing the sheet to conform to molds with deep features or recesses. Likewise, pressure forming is the process where a vacuum is drawn through the mold like vacuum forming, but with additional, positive pressure on the opposite side of the plastic sheet. The combination of positive air pressure on top, and negative air pressure below the plastic sheet forces the plastic sheet into the features of the mold, where the plastic is allowed to cool before removal.

In one useful embodiment, an RFID tag may be embedded in the plastic sheet prior to the target sheet being placed into the thermoforming frame. The RFID tag may initially be embedded in a plastic sheet by, for example, the extrusion or injection molding methods detailed above. Alternatively, another useful embodiment may be where an RFID tag is manually placed onto the thermoforming mold, or physically placed on the plastic sheet just prior to the sheet being drawn into the mold.

For instance, an RFID tag may be placed into a preferred location in a thermoforming mold before the plastic sheet is drawn into the mold. The RFID tag may be inserted into the mold without adhesive, or optionally, with some adhesive, which may be heat activated, such that when the plastic sheet is formed into the mold, the RFID tag becomes embedded in the softened plastic sheet. In the case where an adhesive is used to secure the RFID tag to the mold prior to the actual molding, the adhesive may be released by the heat of the plastic sheet as it is formed, allowing the RFID tag to come free from its placement in the mold and embed securely in the plastic sheet. Placement prior to molding may allow an operator to advantageously place the RFID tag in a position within the mold relative to the desired final location of the RFID tag in the finished plastic article.

Alternatively, an RFID tag may be placed or otherwise embedded in the plastic sheet prior to thermoforming. In yet another useful embodiment, an RFID tag may be mechanically placed or inserted into a plastic sheet after the plastic sheet has been heated and softened prior to being placed onto the thermoforming mold. This placement or insertion may be advantageously done automatically, through mechanical means, or manually.

For example, an automated system may be exemplified by a mechanical system wherein, after a plastic sheet is placed in a thermoforming frame and heated, a mechanical RFID placement device placed or attached an RFID tag to the plastic sheet, optionally using a mild adhesive. The plastic sheet would then automatically be pressed into the mold, where the softened plastic sheet would form around the RFID tag, encasing and effectively embedding it.

Additionally, the present principles may be advantageously applied in plastic lamination as well. In the plastic lamination process, two or more pieces of plastic sheeting are heated and then pressed together, preferably on each side of some other object to be protected. This process is frequently used for identification documents such as driver's licenses, student identification cards, security badges and the like. In one useful embodiment, an RFID tag may be inserted between the plastic lamination sheets prior to heating and sealing, embedding the RFID tag in the plastic during the heating and sealing process. For instance, where a security identification card is being created, a paper card may be made with identifying information, barcodes, photographs, and the like printed on it. The paper card may then be placed between two plastic sheets for lamination purposes, then the entire apparatus heated under pressure. This process fuses the plastic sheets to the paper, and fuses the two plastic sheets to each other around the edges of the paper. In one useful embodiment, an RFID tag may be attached to the inner surface of one of the plastic sheets, or to the paper card insert prior to the lamination process. Preferably, the lamination process would use heat sufficient to fuse the plastic sheets together and embed and encase the RFID tag in the plastic, but not require a temperature high enough to damage the RFID tag.

Skilled practitioners of the art will further recognize that the apparatus and methods described herein are not limited to the manufacture of plastic containers. Plastic articles that may be made by the presently embodied principles may further include, but are not limited to, durable medical bracelets containing medical history and other patient information, drug packaging, food distribution packaging and processing tracking, or human and animal injectable devices containing any manner of information, identifying or otherwise.

Additionally, RFID tags may be advantageously embedded in any manner of plastic identification goods. Such goods embodying the present principles may include, but are not limited to temporary and permanent luggage IDs for use in airline travel and identification, clothing, outerwear, and personal identification tags or identification documents. In particular, RFID tags may be embedded in driver's licenses, passports, credit cards, employment identification and security badges and the like.

In an environment where the RFID molded articles use the RFID information for recycling, the RFID tag allows for an automated method for easily sorting various types of plastics. This method is non-destructive, and more cost efficient than previous methods. In such a sorting method, objects may, for example, be sorted by size, and then sorted by material, the information regarding material having been read from the RFID tag. Plastic articles that may be reused without destructive recycling may then be separated out, after which, the remaining plastic articles may be sent to a chute or collection bin designated for a particular type of plastic.

These and other features and advantages of the present principles may be readily ascertained by one of ordinary skill in the pertinent art based on the teachings herein. It is to be understood that the teachings of the present principles may be implemented in various forms of hardware, either active or passive, and the control systems in various forms of software, hardware, manual operation, or combinations thereof.

Although the illustrative embodiments have been described herein with reference to the accompanying drawings, it is to be understood that the present principles are not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

What is claimed is:

1. An apparatus for injection molding plastic articles with RFID tags integrally molded therein, the apparatus comprising:
an injection molding machine;
a mold having at least one mold cavity, the mold disposed in relation to the injection molding machine such that a liquid plastic resin may be forced into the at least one mold cavity from the injection molding machine; and
at least one RFID injection element capable of delivering at least one RFID tag into the liquid plastic resin.

2. The apparatus of claim 1, the injection molding machine comprising:
a body;
a melt reservoir disposed within the body; and
at least one injection nozzle, the at least one injection nozzle disposed to deliver a liquid plastic resin from the melt reservoir.

3. The apparatus of claim 2, wherein the RFID injection element is positioned delivering the at least one RFID tag into the melt reservoir.

4. The apparatus of claim 2, wherein the RFID injection element is capable of delivering the at least one RFID tag into the at least one injection nozzle.

5. The apparatus of claim 2, wherein the RFID injection element is capable of delivering the at least one RFID tag into the at least one mold cavity.

6. The apparatus of claim 1, wherein the injection molding machine is a plunger type injection molding machine.

7. The apparatus of claim 1, wherein the injection molding machine is a reciprocating screw-type injection molding machine.

8. The apparatus of claim 1, the apparatus further comprising:
a hot runner system, the hot runner system comprising:
a manifold disposed to receive liquid plastic resin from the injection molding machine; and
at least one injector nozzle, each injector nozzle associated with one mold cavity;
wherein the at least one injector nozzle is disposed along the manifold system such that the at least one injector nozzle is capable of delivering the liquid plastic resin to the at associated mold cavity, the at least one RFID injection elements disposed within the injector nozzle such that each of the at least one injector nozzle is capable of delivering at least one RFID tag to only one mold cavity.

9. The apparatus of claim 1, wherein the at least one RFID tag is suspended in a volatile solvent when delivered into the liquid plastic resin.

10. The apparatus of claim 1, wherein the at least one RFID tag encapsulated in a protective covering when delivered into the liquid plastic resin.

11. The apparatus of claim 1, wherein the at least one RFID tag is dimensioned to fit within the RFID injection element such that the introduction of air into the liquid plastic resin is prevented when the RFID tag is injected into the liquid plastic resin.

12. The apparatus of claim 1, wherein the at least one RFID tag contains data relating to at least one material properties of the plastic article.

13. The apparatus of claim 1, wherein the at least one RFID tag contains data related to the contents of the plastic article.

14. The apparatus of claim 1, wherein the at least one RFID tag is writeable.

15. The apparatus of claim 14, wherein the at least one RFID tag is writeable and readable after being integrally molded into an injection molded plastic article.

16. A method for making an injection molded plastic article, the plastic article having at least one RFID tag integrally molded therein, the method comprising:
melting a plastic resin into a liquid plastic resin within an injection molding machine;
beginning injection of the liquid plastic resin into a mold having a mold cavity, the plastic injected into the mold cavity through an injection nozzle disposed within said injection molding machine;
injecting at least one RFID tag into the liquid plastic resin;
finishing injecting the liquid plastic resin into a mold, the RFID tag being carried into the mold cavity.

17. The method of claim 16, wherein the RFID contains data.

18. The method of claim 16, further comprising writing data to the at least one RFID tag.

19. The method of claim 18, wherein the data is written after the finishing injecting of the liquid plastic resin into a mold.

20. A method for sorting at least one plastic article based on at least one property, the method comprising:
reading information from an RFID tag integrally molded within the at least one plastic articles;
determining the type of plastic material the article is made from based on said information;
separating the plastic articles based on the determining of the type of plastic material.

21. A plastic article comprising:
a plastic portion; and
an RFID tag integrally disposed in the plastic portion.

22. The plastic article of claim 21, the RFID tag integrally disposed within the plastic portion by an injection molding process.

23. The plastic article of claim 21, the RFID tag integrally disposed within the plastic portion by an extrusion process.

24. The plastic article of claim 21, the RFID tag integrally disposed within the plastic portion by an injection blow molding process, wherein the plastic portion is a blow molding blank produced through the injection molding process, the blank used as the basis for the blow molding process.

25. The plastic article of claim 21, the RFID tag integrally disposed within the plastic portion by an extrusion blow molding process, wherein the plastic portion is a blow molding blank produced through the extrusion process, the blank used as the basis for the blow molding process.
